(19) United States
(12) Patent Application Publication
(10) Pub. No.: US 2006/0282502 A1
(43) Pub. Date: Dec. 14, 2006

(54) Method and system for translation of electronic data and software transport protocol with reusable components

(76) Inventor: Richard L. Koshak, Sachse, TX (US)

Correspondence Address: BAKER BOTTS LLP, 2001 ROSS AVENUE, 6TH FLOOR, DALLAS, TX, 75201, US

(21) Appl. No.: 11/149,846

(22) Filed: Jun. 10, 2005

(51) Int. Cl. G06F 15/16

(52) U.S. Cl. 709/206

(57) ABSTRACT

According to one embodiment of the invention, a system for communicating messages between applications, comprises an incoming connection component, a core logic component, and an outgoing connection component. The incoming connection component receives messages from a sending application and wraps the messages as a generic object in a message object. The core logic component is coupled to the incoming connection component and receives the message object from the incoming connection component. The outgoing connection component is coupled to the core logic component and receives the message object from the core logic component, unwraps the message object to retrieve the message, prepares the message for delivery to a destination application, and delivers the message to the destination application. The incoming connection component, the core logic component, and the outgoing connection component have standardized face and function together as an integrated unit.

### TECHNICAL FIELD OF THE INVENTION

This invention relates generally to the field of computers and, more particularly, to a method and system for translation of electronic data and software transport protocol with reusable components.

### BACKGROUND OF THE INVENTION

A variety of enterprise software applications and systems include heterogeneous collections of software. Each software application in the system may have its own Application Programming Interface (API), which can include a variety of formats and software transport protocols used to send and receive data (e.g., TCP sockets, CORBA, JMS). Often these APIs are incompatible with one another. Accordingly, problems can arise when one application attempts to communicate with another.

### SUMMARY OF THE INVENTION

According to one embodiment of the invention, a system for communicating messages between applications, comprises an incoming connection component, a core logic component, and an outgoing connection component. The incoming connection component receives messages from a sending application and wraps the messages as a generic object in a message object. The core logic component is coupled to the incoming connection component and receives the message object from the incoming connection component. The outgoing connection component is coupled to the core logic component and receives the message object from the core logic component, unwraps the message object to retrieve the message, prepares the message for delivery to a destination application, and delivers the message to the destination application. The incoming connection component, the core logic component, and the outgoing connection component have standardized interfaces and function together as an integrated unit.

Certain embodiments of the invention may provide numerous technical advantages. For example, a technical advantage of one embodiment may include the capability to provide a transport protocol independent framework. Another technical advantage of another embodiment may include the capability to provide a modular framework, which minimizes changes to the rest of the framework. Yet another technical advantage of another embodiment may include the capability to provide a framework, which allows for the import, activation, reconfiguration, and removal of components at runtime.

Although specific advantages have been enumerated above, various embodiments may include all, some, or none of the enumerated advantages. Additionally, other technical advantages may become readily apparent to one of ordinary skill in the art after review of the following figures and description.

### BRIEF DESCRIPTION OF THE DRAWINGS

For a more complete understanding of example embodiments of the present invention and its advantages, reference is now made to the following description, taken in conjunction with the accompanying drawings, in which:

FIG. 1 is an architecture of a framework, according to an embodiment of the invention;

FIG. 2 is an architecture of a framework, according to another embodiment of the invention;

FIG. 3 illustrates a relation of various interfaces and classes of a framework, according to an embodiment of the invention; and

FIG. 4 is a flow diagram of a message processing 500, according to an embodiment of the invention.

### DETAILED DESCRIPTION OF EXAMPLE EMBODIMENTS OF THE INVENTION

It should be understood at the outset that although example embodiments of the present invention are illustrated below, the present invention may be implemented using any number of techniques, whether currently known or in existence. The present invention should in no way be limited to the example embodiments, drawings, and techniques illustrated below, including the embodiments and implementation illustrated and described herein. Additionally, the drawings are not necessarily drawn to scale.

A variety of enterprise software applications and systems include heterogeneous collections of software. Each software application in the system may have its own Application Programming Interface (API), which can include a variety of formats and software transport protocols used to send and receive data (e.g., TCP sockets, CORBA, JMS). Often these APIs are incompatible with one another. Accordingly, problem can arise when one application attempts to communicate with one another.

Yet further problems can arise when a change occurs to the system (e.g., new applications are added, existing application's APIs are changed, or existing applications are removed). With such occurrences, conventional techniques typically resort to changing the interfaces of the remaining applications to account for the changes to the system. Accordingly, teachings of embodiments of the invention recognize an extensible, component based, protocol independent software messaging framework. According to some embodiments, the framework provides a layer of abstraction between applications that need to communicate with one another, isolating the actual APIs and protocols used by each application and providing a custom, yet reusable adaptor component. Teachings of other embodiments of the invention additionally recognize a framework, which provides an ability to add new capabilities to the system such as message routing, simulation time control, and message monitoring.

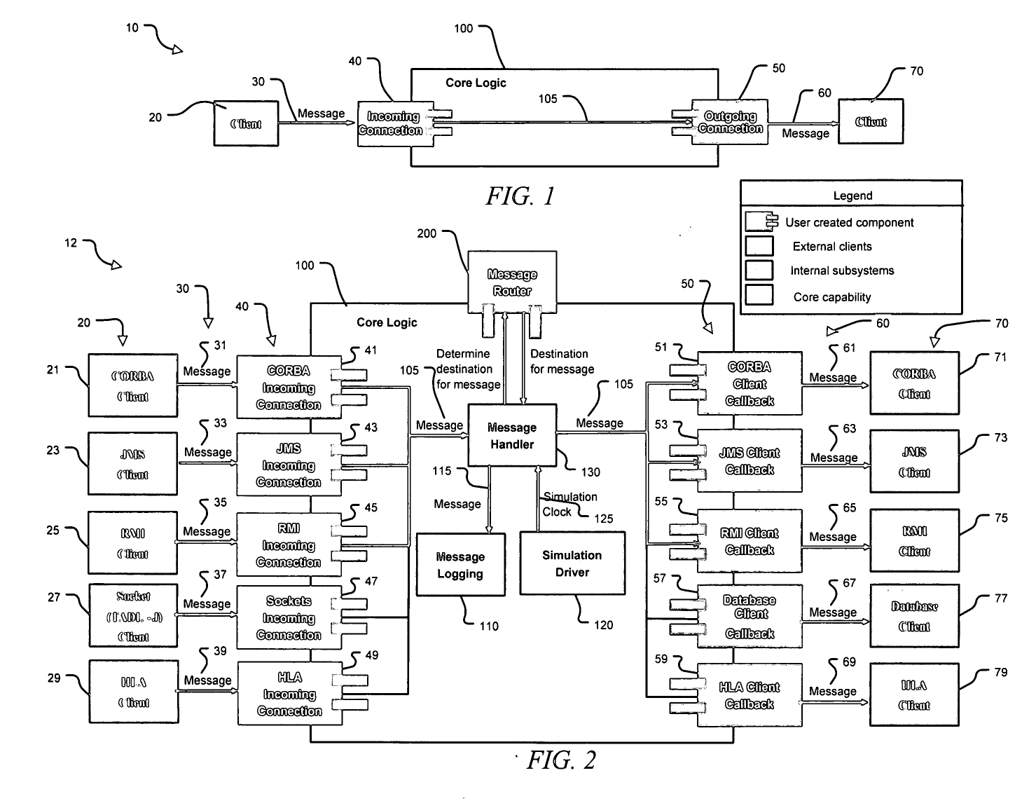

FIG. 1 is an architecture of a framework 10, according to an embodiment of the invention. The framework 10 of FIG. 1 facilitates the transportation of a message from a sending client 20 to a receiving client 70. In transporting this message, the sending client 20 may be using a different communication protocol than the destination client 70. Accordingly, to transport the message between the sending client 20 and the destination client 70 the framework 10 may be utilized. The framework 10 in the embodiment of FIG. 1 includes three interfaces: a core logic component 100, an incoming connection component 40, and an outgoing connection component 50. These three interfaces, when implemented, may form an integrated unit.

In operation, the sending client 20 (e.g., an application or program) generates a message 30 using its native application program interface (API) and associated communication protocol. The message 30 may take on a variety of forms, including, but not limited to a function call in a remote procedure call (RPC), a messaging based message, an XML string, or a bit packed binary data packet. Further forms and/or types of messages 30 will be described below.

After generating the message 30, the sending client 20 may communicate the message 30 to the incoming connection component 40. The incoming connection component 40 upon receiving the message 30 from the sending client 20, wraps the message 30 into a standard format utilized by the core logic component 100 (e.g., a MessageObject 105, described in further details below) and passes the MessageObject 105 to the core logic component 100. The incoming connection component 40, according to particular embodiments, may be a runtime configurable component.

Upon receiving the MessageObject 105, the core logic component 100 may communicate the wrapped MessageObject 105 to the outgoing connection component 50. Although not expressly shown in this embodiment, the MessageObject 105 may undergo processing in the core logic component 100 as will be described in further details below.

The outgoing connection component 50, upon receiving the MessageObject 105 from the core logic component 100 may unwrap the MessageObject 105 and do any appropriate message transformation needed to send the message 60 to the destination client 70. For example, the outgoing connection component 50 may place the message 60 in the native API of the destination client 70. Similar to the incoming connection component 40, the outgoing connection component 50 in this embodiment may be a runtime configurable component.

If needed, message translation (e.g., converting the message format) can occur at any point in the above process. For example, message translation may occur at the incoming connection 40, in the core logic component 100, or at the outgoing connection component 50. In embodiments of the invention, the MessageObject 105 may retain the message format of the sending client 20 when the message 30 is initially wrapped in the MessageObject 105 at the incoming connection component 40. Accordingly, in some embodiments, the message may undergo only one translation, for example, a translation from a message format of message 30 to a message format of message 60.

The incoming connection components 40, the outgoing connection components 50, and the core logic component 100 in particular embodiments may all be components with standardized interfaces. Accordingly, the core logic component 100 may be replaced or upgraded with a more capable core logic component (for example, a core logic component that includes message logging, message routing, and simulation time control) while reusing the same incoming connection components 40 and outgoing connection components 50. Further details of an embodiment of such a configuration are described below with reference to FIG. 2.

The components of the framework 10 may be implemented with a variety of different programming languages, including, but not limited to Java. Although Java will be used to described one embodiment, other embodiments may utilize other programming languages.

FIG. 2 is an architecture of a framework 12, according to another embodiment of the invention. The embodiment of FIG. 2 illustrates some of the variety of different incoming connection components 40 and outgoing connection components 50 that may be utilized to support a variety of transportation protocols used by sending clients 20 and destination clients 40. The embodiment of FIG. 2 additionally illustrates processing in the core logic component 100, according to one embodiment.

The sending clients 20 may include, but are not limited to, a Common Object Request Broker Architecture (CORBA) sending client 21, a Java Messaging Service (JMS) sending client 23, a Remote Method Invocation (RMI) sending client 25, a socket sending client 27, and a High Level Architecture (HLA) sending client 29. Similarly, the destination clients 70 may include, but are not limited to a CORBA destination client 71, a JMS destination client 73, a RMI destination client 75, a database destination client 77, and an HLA destination client 79. In some embodiments, the sending client 70 and the destination client 70 may be the same application or program.

Each of the sending clients 20 may utilize a different transportation protocol in the transport of its respective messages 30 (e.g., messages 31, 33, 35, 37, 39) and each of the destination clients 70 may expect to receive a message formatted with a particular protocol (e.g., messages 61, 63, 65, 67, 69). Accordingly, incoming connection components 40 (e.g., a CORBA incoming connection component 41, a JMS incoming connection component 43, a RMI incoming connection component 45, sockets incoming connection component 47, and HLA incoming connection component 49) may be provided to receive messages 30 from each respective protocol for each respective sending client 20. Similarly, outgoing connection components 50 (e.g., a CORBA outgoing connection component 51, a JMS outgoing connection component 53, a RMI outgoing connection component 55, a MSDB outgoing connection component 57, and an HLA outgoing connection component 59) may be provided to prepare messages 60 for delivery to the destination client 70.

Similar to that described with reference to FIG. 1, each of the incoming connection components 40 in FIG. 2 may receive a respective message 30 and wrap that message into a MessageObject 105 for processing in the core logic component 100. Likewise, each of the outgoing connection components 50 may receive a MessageObject 105 from the core logic component 100, unwrap the MessageObject 105, and prepare a respective message 60 for delivery to a respective destination client 70.

In the framework 12 of FIG. 2, the core logic component 100 includes a message handler component 130, a message logging component 110, and a simulation driver 120. A message router component 200 is additionally shown coupled to the core logic component 100. Each of these components may be used to process MessageObjects 105. For some MessageObjects 105, the message handler component 130 may simply forward the MessageObject 105 to the appropriate outgoing connection component 50. For other messages, the message handler 130 may receive a MessageObject 105 and send a logging message 115 to the message logging component 110 to log any of a variety of information, concerning the MessageObjects 105. For yet other MessageObjects 105, the message handler 130 may communicate with the message router 200 to determine where a particular MessageObject 105 should be routed. For still yet other MessageObjects 105, the message handler 130 may receive a clock information message 125 from the simulation driver 120 to add clocking or timing information to the MessageObject 105. For particular MessageObjects 105, the message handler 130 may utilize more than one or all of the remaining components in the processing in the core logic component 100. Further processing of the MessageObjects 105 in the core logic component 100 may additionally occur in other embodiments of the invention. In particular embodiments, the processing may involve looking at the original message 30 and/or information added by the incoming connection component 40 in creating the MessageObject 105. In other embodiments, the processing in the core logic component 100 may involve converting the format of the original message 30 in the MessageObject 105.

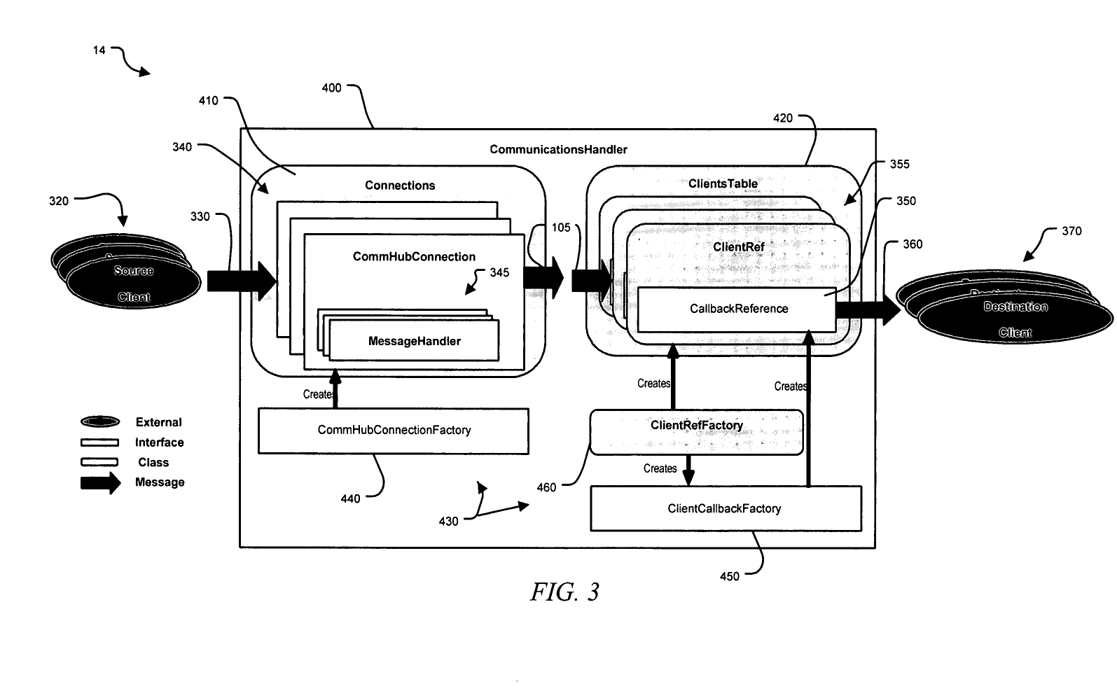

FIG. 3 illustrates a relation of various interfaces and classes of a framework 14, according to an embodiment of the invention. The framework 14 of FIG. 3 may be utilized as a foundation to create the framework 12 of FIG. 2. The framework 14 of FIG. 3 includes a CommunicationsHandler 400, which according to particular embodiments, may implement the logic of the core logic component 100 of FIGS. 1 and 2 to communicate messages 330 from sending clients 320 into MessageObjects 105 and then into messages 360 destined for destination clients 370. The CommunicationsHandler 400 in particular embodiments may also be responsible for the creation, destruction and management of components. The CommunicationsHandler 400 of FIG. 3 includes factories 430, CallbackReference objects 350, CommHubConnection objects 340, MessageHandler objects 345, ClientRef objects 355, a Connections table 410, and a ClientsTable 410.

The creation of some of the components of framework 14 may require a reading from initialization files and configuration files. Accordingly, the code needed to generate some of these components may be encapsulated in a component factory 430. The embodiment of FIG. 3 includes three component factories 430: a CommHubConnectionFactory 440, a ClientRefFactory 460, and a ClientCallbackFactory 450. The CommHubConnectionFactory 440 is used to create the CommHubConnections 340. As an example, to create a JMS CommHubConnection object, a JMS CommHubConnectionFactory may be utilized. In particular embodiments, the CommHubConnectionFactory 440 may convert configuration text, for example, from a file or database, into an actual object (e.g., a CommHubConnection object 340) that knows how to receive JMS messages. The CommHubConnectionFactory 440 in the creation of the CommHubConnections 340 isolates the CommHubConnections 340 to hide the various differing data and initialization schemes used by different transport protocols. As an example, the data and initialization required to connect to a CORBA sending client 21 of FIG. 2 will be vastly different from those required to connect to an HLA sending client 29 of FIG. 2.

The ClientCallbackFactory 450 and the ClientRefFactory 460 may operate in a similar manner to the CommHubConnectionFactory 440 to create CallbackReference objects 350 and ClientRef objects 355. In particular embodiments, the initialization data may be passed into the component factories 430 as a parsed XML document. And, the contents and structure of the XML document may be unique to the individual component factories 430. Examples of configuration files include, but are not limited to machine names, port numbers, and third party libraries.

The CommHubConnection objects 340 may generally correspond to the incoming connection components 40 of FIG. 2. The CommHubConnection objects 340 are interfaces implemented by the incoming connection components 40 to handle messages from the sending clients 20. The CommHubConnection objects 345 define the methods and/or algorithms used by the core logic component 100 to manage the connections. The CommHubConnection objects 345 may encapsulates the code used to receive messages 30 from sending clients 20. As briefly identified above, the connection components 40 through the interface of the CommHubConnection objects 345 may extract data from the messages 30, 330 and place the data from and/or wrap the messages 30 into a MessgeObject 105. The CommHubConnections 345 may then pass the MessageObject 105 to the CommunicationsHandler 400 for processing. In such processing, the CommunicationsHandler 345 may process the MessageObject 105 in a variety of manners described above.

The MessageHandler object 345 is an interface that may be used to provide message translation capabilities based on individual messages. For example, if a CommHubConnection object 340 receives a message that needs to be transformed, then a MessageHandler 345 can be implement and registered to do the transformation. The MessageHandler may use a chain of responsibility design pattern so new MessageHandler objects 345 may be added without affecting the rest of the code. A general discussion of design patterns is provided in the book entitled Design Patterns: Elements of Reusable Object-Oriented Software by Gamma, Helm, Johnson, and Vlissides, Addison-Wesley Professional (1995), ISBN No. 0201633612.

Once instantiated, the CommHubConnections 340 may be stored in a Connections table 410. The Connections table 400 is a class that stores and maintains a collection of the CommHubConnections 340. In other words, the Connections table 400 may be a wrapping up of the interfaces for the incoming connection components 40 from FIG. 2. In managing the CommHubConnections 345, the Connections table 400 may utilize a variety of methods, including, but not limited to, add, get, and remove methods.

The ClientRef objects 355 contain information about a destination client 70, including, but not necessarily limited to, the name and a simulator flag for the destination client 70. The ClientRef objects 355 may also contain instances of the CallbackReference objects 350 that implement the code necessary to send messages to a destination client 70.

The Callback References 350 may generally correspond to the outgoing connection components 50 of FIG. 2. The CallbackReference objects 355 of FIG. 3 are interfaces implemented by outgoing connections 50. The CallbackReference objects 350 define the methods and/or algorithms used by the core logic component 100 to manage outgoing connections 50 and send messages to destination clients 70. Accordingly, the CallbackReference objects 350 may encapsulates the custom code used to send messages to the destination clients 70. Once instantiated, the ClientRefs 350 may be stored in the ClientsTable 420.

The ClientsTable 420 is a class that stores and maintains a collection of ClientRef objects 340. In managing the ClientRef objects 340, the ClientsTable 420 may utilize a variety of methods, including, but not limited to, add, get, and remove methods.

The MessageObject 105, briefly introduced above, may be a class that encapsulates a message as it passes through the framework 14. The MessageObject 470 may contain a variety of information, including, but not limited to, the name of the sending client 220 that sent the message (if available), the name of the destination client 70, the time the message was sent and the type of message (e.g., a root element of an XML message). The actual message may be stored as a generic object to maximize flexibility (e.g. passing of binary messages). In particular embodiments, the MessageObject 105 may be a string of characters or an XML formatted message.

As referenced above, the core logic component 100 may be expanded. For example, a child interface may be created using inheritance that includes changes. Such an implementation may provide a fast and direct way to make additions. Additionally, the MessageHandler object 345 may send messages to the core logic component 100, itself. Such an implementation may leave the interface untouched yet allow components and external applications to interact with the core logic component 100. This latter approach may be used particular embodiments as one implementation to enable runtime.

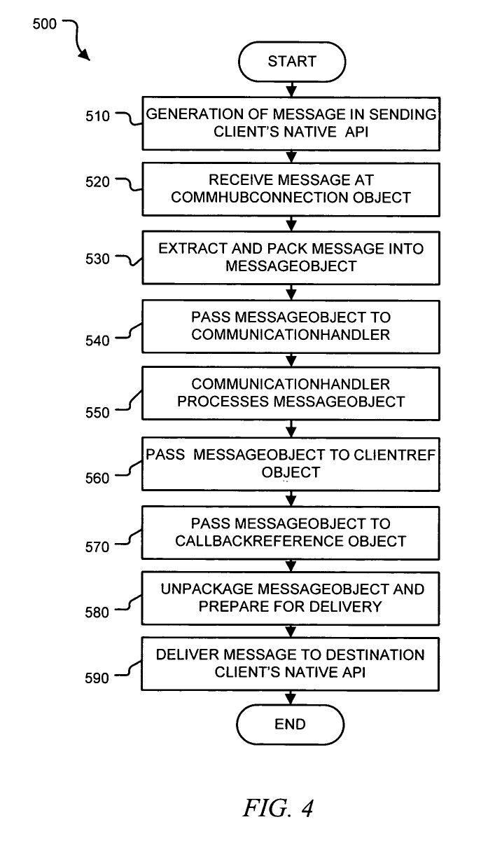

FIG. 4 is a flow diagram of a message processing 500, according to an embodiment of the invention. With description of the message processing 500 of FIG. 4, reference will additionally be made to FIGS. 2 and 3. The message processing 500 may begin at a step 510 with the generation of the message 30, 330 in the native API of the sending client 20, 320. As described above, the message 30, 330 may take on a variety of forms, including, but not limited to a function call in CORBA, a JMS message, an XML string, or a bit packed binary data packet.

The message processing 500 may proceed to a receipt of the message 30, 330 by an interface of one of the CommHubConnection objects 340 at step 520. In receiving the message, the Connections table 410 may be listening for incoming messages 30, 330 and implement the pertinent CommHubConnection object 340 to receive the messages 30, 330 from the sending client 20, 320. For example, the Connections table 410 may implement a JMS CommHubConnection object upon receiving a JMS message.

The message processing 500 may proceed to step 530 where the CommHubConnection object 340 extracts the message 30, 330 and packs the message into a MessageObject 105. The CommHubConnection object 340 in packaging the MessageObject 105 may include any pertinent information, for example, the name of the sending client 20, 320 the name of destination client 70, 370 and the time the message 30, 330 was sent. The CommHubConnection object 340 may then pass the MessageObject 105 to the CommunicationsHandler 400 at step 540.

The CommunicationsHandler 400 may process the MessageObject 105 at step 550. A variety of different process may be run on the MessageObject 105, depending on the features of the core component 100 and/or the CommunicationsHandler 400. In some embodiments, the processing may simply be identifying where the MessageObject 105 needs to be sent.

The MessageObject 105 may then be passed to one of the ClientRef objects 355 at step 560 to determine the appropriate destination client 70, 370. The ClientRef object 355 may then pass the MessageObject 105 to a corresponding CallbackReference object 350 at step 570. At step 580, the CallbackReference object 350 may unpack the message 60, 360 from the MessageObject 105 and prepare the message 60, 360 for delivery, for example using any suitable code which may be necessary for such delivery.

Then, the message 60, 360 may be delivered to a native API of the destination client 70, 370 at step 590. As referenced above, in particular embodiments the message may be translated from one format to another at any stage in the process. For example, in some embodiments, the translation may occur at the incoming connection component 40. In other embodiments, the translation may occur in another component in the core logic component 100. In yet further embodiments, the translation may occur at the outgoing connection component 50. In still other embodiments, the message may not need to be translated at all. As referenced above, if such a translation were to occur, the message may undergo only a single as compared to multiple translations utilized with a standardized messaging bus (e.g., JMS). Accordingly, in particular embodiments of the invention, the core logic component 100 may be protocol independent—not relying on any particular standardized protocol.

Although the present invention has been described with several embodiments, a myriad of changes, variations, alterations, transformations, and modifications may be suggested to one skilled in the art, and it is intended that the present invention encompass such changes, variations, alterations, transformation, and modifications as they fall within the scope of the appended claims.

### API DOCUMENTATION EXAMPLE

The following is an examples for the interfaces and class of FIG. 4.

Interface CallbackReference

public interface CallbackReference

Interface that must be implemented by all classes that are used as a callback class for a registered client.

Method Summary

| | |
|---|---|
| void | _continue( ) |
| | Sends the continue message to the client via the callback |
| | mechanism. |
| void | closeConnections( ) |
| | Closes open communications connections. |
| ClientRef | getParent( ) |
| | Returns the parent client for this callback |
| void | init(int timeStep, java.lang.String startTime) |
| | Sends the init message to the client via the callback |
| | mechanism. |
| short | processMessage(java.lang.String source, |
| | java.lang.Object message) |
| | Sends a message to the client via the callback mechanism. |
| void | quit(short code, java.lang.String reason) |
| | Sends the quit message to the client via the callback |
| | mechanism. |
| void | setParent(ClientRef client) |
| | Sets the parent client for this callback |

Method Detail

processMessage
public short processMessage(java.lang.String source,

```
      java.lang.Object message)
  throws CommunicationsException
Sends a message to the client via the callback mechanism.
Parameters:
source - name of the client sending the message
message - contents of the message (use toString( ) for text messages)
Returns:
if not 0, an error occured processing the message
Throws:
CommunicationsException - if there is a problem communicating with client
via the callback mechanism. When implementing this method, package up any
specific exceptions into this exception.
```

quit
public void quit(short code,

```
      java.lang.String reason)
  throws CommunicationsException
Sends the quit message to the client via the callback mechanism.
Parameters:
code - reason code
reason - text message explaining the reason
Throws:
CommunicationsException - if there is a problem communicating with client
via the callback mechanism. When implementing this method, package up any
specific exceptions into this exception.
```

init
public void init(int timeStep,

```
      java.lang.String startTime)
  throws CommunicationsException
Sends the init message to the client via the callback mechanism.
Parameters:
timeStep - number of seconds per time step
startTime - start time of the simulation in yyyy:MM:dd kk:mm:ss format
Throws:
CommunicationsException - if there is a problem communicating with client
via the callback mechanism. When implementing this method, package up any
specific exceptions into this exception.
```

_continue
public void _continue( )

throws CommunicationsException
Sends the continue message to the client via the callback mechanism. This
gives the client permission to process the next time step.
Throws:
CommunicationsException - if there is a problem communicating with client
via the callback mechanism. When implementing this method, package up any
specific exceptions into this exception.

closeConnections
public void closeConnections( )

throws CommunicationsException
Closes open communications connections.
Throws:
CommunicationsException - if there is a problem closing the connection

setParent
public void setParent(ClientRef client)

Sets the parent client for this callback
Parameters:
client - the parent client

getParent
public ClientRef getParent( )

Returns the parent client for this callback
Returns:
the parent client, or null if one has not been set

Interface ClientCallbackFactory

public interface ClientCallbackFactory

Interface that must be implemented by any factory that creates callback objects. These factories will get all the parameters they need from the SaxDocument passed in to generate the callback object and setup all connections to allow for communications.

Method Summary

| | |
|---|---|
| CallbackReference | createCallback(org.w3c.dom.Element doc, |
| | CommunicationsHandler handler) |
| | Called to create a CallbackReference based |
| | on the info contained in doc. |

Method Detail

```
createCallback
public CallbackReference createCallback(org.w3c.dom.Element doc,
CommunicationsHandler handler)
        throws
ClientCallbackFactoryException
  Called to create a CallbackReference based on the info contained in doc.
  Parameters:
  doc - contains all the info needed by the factory to create and setup the
  callback
  handler - many callbacks require some sort of direct communication
  with the main CommunicationsHandler
  Returns:
  a valid callback reference with communications connections configured
  Throws:
  ClientCommFactoryException - if there is a problem creating and
  configuring the callback
  ClientCallbackFactoryException
```

Class ClientCallbackFactoryException

public class ClientCallbackFactoryException

extends java.lang.Exception

Exception thrown when the ClientCommFactory encounters an error generating a CallbackReference object.

Constructor Summary

```
ClientCallbackFactoryException( )
  Constructor
ClientCallbackFactoryException(java.lang.String message)
  Constructor
ClientCallbackFactoryException(java.lang.String message,
java.lang.Throwable cause)
  Constructor
ClientCallbackFactoryException(java.lang.Throwable cause)
  Constructor
```

Methods inherited from class java.lang.Throwable

fillInStackTrace, getCause, getLocalizedMessage, getMessage,
getStackTrace, initCause, printStackTrace, printStackTrace,
printStackTrace, setStackTrace, toString

Methods inherited from class java.lang.Object

clone, equals, finalize, getClass, hashCode, notify, notifyAll, wait,
wait, wait

Constructor Detail

```
ClientCallbackFactoryException
public ClientCallbackFactoryException( )
  Constructor
ClientCallbackFactoryException
public ClientCallbackFactoryException(java.lang.String message)
  Constructor
Parameters:
  message - error message
ClientCallbackFactoryException
public ClientCallbackFactoryException(java.lang.String message,
          java.lang.Throwable cause)
  Constructor
Parameters:
  message - error message
  cause - nested throwable
ClientCallbackFactoryException
public ClientCallbackFactoryException(java.lang.Throwable cause)
  Constructor
Parameters:
  cause - nested throwable
```

Class ClientRef

public class ClientRef

extends java.lang.Object

Represents a client to the CommHub. It contains all the relevant information about a client including the client's name, callback object, and whether it is a simulator and whether it is registered. All communication to clients take place via this object. In order to make storage and playback of the communications that come from this client easier, this object has its own log file and logger.

FIELD SUMMARY

| | |
|---|---|
| protected | _callback |
| CallbackReference | The clients callback reference |
| protected | _clientName |
| java.lang.String | The registered name of the client |
| protected boolean | _done |
| | True if the client has issued a done |
| protected | _logger |
| LogServer | The logger |
| protected Queue | _messages |
| | Queue of MessageObjects |
| protected boolean | _prereg |
| | True if the client is a preregistered client |
| protected boolean | _registered |
| | True if the client is currently registered |
| protected double | _regTime |
| | The simulation time the client registered |
| protected boolean | _simulator |
| | True if the client is a simulator (ie responds to |
| | init and continues) |

Constructor Summary

ClientRef(boolean simulator, boolean prereg,
CallbackReference callback, java.lang.String name, double regTime,
boolean registered, java.lang.String logDir)
The constructor.

Method Summary

| | |
|---|---|
| void | _continue( ) |
| | Send a continue via the callback |
| void | addMessage(MessageObject mo) |
| | Adds an incomming message to the clients message |
| | queue. |
| void | closeConnections( ) |
| | Closes the communications connections |
| void | finishLogging( ) |
| | Stops the logger's thread and blocks until it finishes |
| | logging |
| java.lang.String | getName( ) |
| | Returns the clients name. |
| MessageObject | getNextMessage( ) |
| | Returns the next message in the queue, removing |
| | it from the queue |
| double | getRegTime( ) |
| | Returns the time the client registered |
| void | init(int timeStep, java.lang.String startTime) |
| | Init the client via the callback |
| boolean | isDone( ) |
| | Returns true if the client is done processing for the |
| | current time step. |
| boolean | isPreregisterd( ) |
| | Returns the preregistration flag. |
| boolean | isRegistered( ) |
| | Returns the registered flag |
| boolean | isSimulator( ) |
| | Returns the simulator flag. |
| void | logMessage(MessageObject mo) |
| | Logs a message to the clients log file |
| MessageObject | peekMessage( ) |
| | Returns the next message on the client's message |
| | queue without removing it. |
| void | quit(short code, java.lang.String reason) |
| | Quit the client via the callback |
| short | sendMessageToClient(MessageObject mo) |
| | Sends the passed in message to the client through |
| | the callback reference. |
| void | setDone(boolean state) |
| | Sets the clients done flag. |
| void | setRegistered(boolean registered) |
| | Sets the registered flag |
| void | setRegTime(double newRegTime) |
| | Sets the time the client registered |

Methods inherited from class java.lang.Object

clone, equals, finalize, getClass, hashCode, notify, notifyAll,
toString, wait, wait, wait

Field Detail

```
_simulator
protected boolean _simulator
    True if the client is a simulator (ie responds to init and continues)
_prereg
protected boolean _prereg
    True if the client is a preregistered client
_clientName
protected java.lang.String _clientName
    The registered name of the client
_messages
protected Queue _messages
    Queue of MessageObjects
_regTime
protected double _regTime
    The simulation time the client registered
_registered
protected boolean _registered
    True if the client is currently registered
_logger
protected LogServer _logger
    The logger
_done
protected boolean _done
    True if the client has issued a done
_callback
protected CallbackReference _callback
    The clients callback reference
```

Constructor Detail

```
ClientRef
public ClientRef(boolean simulator,
        boolean prereg,
        CallbackReference callback,
        java.lang.String name,
        double regTime,
        boolean registered,
        java.lang.String logDir)
throws java.io.IOException
```

The constructor.

Parameters:

simulator—if true, this object represents a simulator

prereg—if true, this object represents a preregistered client

callback—the callback reference used for communication

name—the clients registered name

regTime—the time the client registered

registered—if true, the client is currently registered

logDir—the directory in which to place the log file

Throws:

java.io.IOException—if there is a problem creating the log file

Method Detail

```
addMessage
public void addMessage(MessageObject mo)
      Adds an incomming message to the clients message queue.
      Parameters:
      mo - the message object that contains the message and message meta data
logMessage
public void logMessage(MessageObject mo)
      Logs a message to the clients log file
      Parameters:
      mo - The message to log
peekMessage
public MessageObject peekMessage( )
      Returns the next message on the client's message queue without removing it.
      Returns:
      the next message in the queue
getNextMessage
public MessageObject getNextMessage ( )
      Returns the next message in the queue, removing it from the queue
      Returns:
      the next message in the queue
sendMessageToClient
public short sendMessageToClient(MessageObject mo)
                throws CommunicationsException
      Sends the passed in message to the client through the callback reference.
      Parameters:
      mo - the message
      Returns:
      if not 0, an error occured
      Throws:
      CommunicationsException - if there is a problem sending the message via
      the callback
finishLogging
public void finishLogging( )
            throws java.lang.InterruptedException
      Stops the logger's thread and blocks until it finishes logging
      Throws:
      java.lang.InterruptedException
quit
public void quit(short code,
          java.lang.String reason)
        throws CommunicationsException
      Quit the client via the callback
      Parameters:
      code - reason for the quit
      reason - text reason for the quit
      Throws:
      CommunicationsException - if there is a problem sending the message via
      the callback
init
public void init(int timeStep,
          java.lang.String startTime)
        throws CommunicationsException
      Init the client via the callback
      Parameters:
      timeStep - number of seconds per time step
      startTime - start time in hh:mm:ss dd:mm:yy format
      Throws:
      CommunicationsException - if there is a problem sending the message via
      the callback
₋ continue
public void ₋ continue( )
          throws CommunicationsException
      Send a continue via the callback
      Throws:
      CommunicationsException - if there is a problem sending the message via
      the callback
getName
public java.lang.String getName( )
      Returns the clients name. Note that a client cannot change its name after
      registering.
      Returns:
      The client's registered name
setRegTime
public void setRegTime(double newRegTime)
      Sets the time the client registered
      Parameters:
      newRegTime - the number of seconds since the simultaion started
getRegTime
public double getRegTime( )
      Returns the time the client registered
      Returns:
      the number of seconds since the start of the simulation that the client
      registered.
setRegistered
public void setRegistered(boolean registered)
      Sets the registered flag
      Parameters:
      registered - true when the client is registered
isRegistered
public boolean isRegistered( )
      Returns the registered flag
      Returns:
      true if the client is currently registered
isSimulator
public boolean isSimulator( )
      Returns the simulator flag. Note that a client cannot change its simulator status at
      runtime.
      Returns:
      true if the client is a simulator
isPreregisterd
public boolean isPreregisterd( )
      Returns the preregistration flag. Note that a client cannot change its
      preregistration status.
      Returns:
      false if the client was registered before CommHub started
isDone
public boolean isDone( )
      Returns true if the client is done processing for the current time step. This
      function only makes sense if ₋ simulator is true
      Returns:
      true if the client is done processing for the current time step
setDone
public void setDone(boolean state)
      Sets the clients done flag.
      Parameters:
      state - the new flag
closeConnections
public void closeConnections( )
            throws CommunicationsException
      Closes the communications connections
      Throws:
      CommunicationsException
```

Class ClientRefFactory

public class ClientRefFactory

extends java.lang.Object

A factory that takes in a set of parameters and generates a ClientRef object with a valid callback object. Most of the needed information is in the SaxDocument, including the class that is the ClientCommFactory (factory to produce the callback and setup any other communications needed).

Constructor Summary

ClientRefFactory( )

Method Summary

| | |
|---|---|
| static ClientRef | createClientRef(org.w3c.dom.Element doc, |
| | CommunicationsHandler commHandler, boolean preReg, |
| | java.lang.String logDir) |
| | Produces a ClientRef object with all the appropriate |
| | settings an a connected callback object. |

Methods inherited from class java.lang.Object

clone, equals, finalize, getClass, hashCode, notify, notifyAll,
toString, wait, wait, wait

Constructor Detail

ClientRefFactory
public ClientRefFactory( )

Method Detail

```
createClientRef
public static ClientRef createClientRef(org.w3c.dom.Element doc,
CommunicationsHandler commHandler,
                boolean preReg,
                java.lang.String logDir)
            throws ClientRefFactoryException
```

Produces a ClientRef object with all the appropriate settings an a connected callback object.

Parameters:

doc—contains all the relevant client information, including the name and how to build the callback object

commHandler—used to obtain other information not in doc, such as the current simulation time

preReg—the preregistration flag. Preregistered clients are treated slightly differently then normal clients.

logDir—directory where the client's log file will be created. The log file will be log where name is the name attribute in the client element of doc.

Returns:

a valid client ref with all the communications already configured

Throws:

ClientRefFactoryException—if there is any problem generating the ClientRef

Class ClientRefFactoryException

public class ClientRefFactoryException

extends java.lang.Exception

Exception thrown when the ClientRefFactory encounters an error generating a ClientRef object.

Constructor Summary

```
ClientRefFactoryException( )
  Constructor
ClientRefFactoryException(java.lang.String message)
  Constructor
ClientRefFactoryException(java.lang.String message,
java.lang.Throwable cause)
  Constructor
ClientRefFactoryException(java.lang.Throwable cause)
  Constructor
```

Methods inherited from class java.lang.Throwable

fillInStackTrace, getCause, getLocalizedMessage, getMessage,
getStackTrace, initCause, printStackTrace, printStackTrace,
printStackTrace, setStackTrace, toString

Methods inherited from class java.lang.Object

clone, equals, finalize, getClass, hashCode, notify, notifyAll, wait,
wait, wait

Constructor Detail

```
ClientRefFactoryException
public ClientRefFactoryException( )
  Constructor
ClientRefFactoryException
public ClientRefFactoryException(java.lang.String message)
  Constructor
Parameters:
  message - error message
ClientRefFactoryException
public ClientRefFactoryException(java.lang.String message,
          java.lang.Throwable cause)
  Constructor
Parameters:
  message - error message
  cause - nested throwable
ClientRefFactoryException
public ClientRefFactoryException(java.lang.Throwable cause)
  Constructor
Parameters:
  cause - nested throwable
```

Class ClientsTable

public class ClientsTable

extends java.util.Hashtable

Stores and performs common operations on all the clients that are or were registered with CommHub.

| | |
|---|---|
| protected | _log |
| LogServer | Used to report errors, assumes it has already been set up |

Constructor Summary

ClientsTable( )
Default constructor

Method Summary

| | |
|---|---|
| boolean | addClient(ClientRef client) |
| | Adds a new client to the table. |
| boolean | clean( ) |
| | Iterates through the table and closes the |
| | logger and removes any client that is markes |
| | as not registered. |
| void | continueClients( ) |
| | Send continue to all the clients |
| void | deregister(java.lang.String clientName) |
| | Changes the indicated client's registration flag to |
| | false. |
| void | finishLogging( ) |
| | Stops all the clients loggers and waits for them to |
| | finish writing their logs to the destination. |
| ClientRef | getClient(java.lang.String clientName) |
| | Returns the indicated client |
| int | getNumDone( ) |
| | Returns the number of registered clients that have |
| | sent a done |
| int | getNumSims( ) |
| | Calculates the number of registered simulation |
| | clients |
| java.util.Collection | getRealtimeClients( ) |
| | Returns a collection of the registered |
| | realtime clients |
| java.util.Collection | getSimClients( ) |
| | Returns a collection of the registered simulation |
| | clients |
| void | initClients(int timeStep, |
| | java.lang.String startTime) |
| | Initialize all the clients |
| boolean | isDone( ) |
| | Returns true if all the registered simulators |
| | are done |
| boolean | isRegistered(java.lang.String clientName) |
| | Returns true if the client is registered |
| boolean | isSimulator(java.lang.String clientName) |
| | Returns true if the indicated client is a simulator |
| void | resetClientsDone( ) |
| | Resets all simulation client's done flag to false |
| void | sendQueuedMessages(double currentTime) |
| | Send all the messages on each client's queue |
| | up to the passed in time. |
| void | sendQuitToClients(short code, |
| | java.lang.String source, |
| | java.lang.String message) |
| | Send a quit to all registered clients, removing any |
| | deregistered clients along the way. |
| void | sendQuitToSimClients(short code, |
| | java.lang.String source, |
| | java.lang.String message) |
| | Send a quit to all registered simulation clients, |
| | removing any deregistered clients along the way. |

Methods inherited from class java.util.Hashtable

clear, clone, contains, containsKey, containsValue, elements,
entrySet, equals, get, hashCode, isEmpty, keys, keySet, put, putAll,
rehash, remove, size, toString, values

Methods inherited from class java.lang.Object
finalize, getClass, notify, notifyAll, wait, wait, wait

Field Detail

_log
protected LogServer_log

Used to report errors, assumes it has already been set up

Constructor Detail

ClientsTable
public ClientsTable( )

Default constructor

Method Detail

```
sendQuitToClients
public void sendQuitToClients(short code,
            java.lang.String source,
            java.lang.String message)
    Send a quit to all registered clients, removing any deregistered clients along
    the way.
    Parameters:
    code - reason code
    source - where the quit originated
    message - text reason
sendQuitToSimClients
public void sendQuitToSimClients(short code,
              java.lang.String source,
              java.lang.String message)
    Send a quit to all registered simulation clients, removing any deregistered
    clients along the way.
    Parameters:
    code - reason code
    source - where the quit originated
    message - text reason
finishLogging
public void finishLogging( )
    Stops all the clients loggers and waits for them to finish writing their logs to
    the destination. If there is an error stopping the logger, note of the error is
    made in the log.
getNumSims
public int getNumSims( )
    Calculates the number of registered simulation clients
    Returns:
    number of registered simulation clients
addClient
public boolean addClient(ClientRef client)
    Adds a new client to the table.
    Parameters:
    client - the new client
    Returns:
    false if there is already a client with that name currently registered.
initClients
public void initClients(int timeStep,
            java.lang.String startTime)
    Initialize all the clients
    Parameters:
    timestep - number of seconds per time step
    startTime - start time in hh:mm:ss yy:mm:dd format
continueClients
public void continueClients( )
    Send continue to all the clients
isRegistered
public boolean isRegistered(java.lang.String clientName)
    Returns true if the client is registered
    Parameters:
    clientName - name of the client
    Returns:
    false if it is not registered
getClient
public ClientRef getClient(java.lang.String clientName)
    Returns the indicated client
    Parameters:
    clientName - name of the client
    Returns:
    null if the client is not registered
sendQueuedMessages
public void sendQueuedMessages(double currentTime)
    Send all the messages on each client's queue up to the passed in time. If a
    message is destined for a client that is no longer registered, then a note is made in the
    logs and the message is skipped. This can only occur if the destination
    client deregistered and was removed after the message was queued.
    Parameters:
    currentTime - time to send all queued messages that arrived before
isDone
public boolean isDone( )
    Returns true if all the registered simulators are done
    Returns:
    false if one or more registered simulators are not done
resetClientsDone
public void resetClientsDone( )
    Resets all simulation client's done flag to false
isSimulator
public boolean isSimulator(java.lang.String clientName)
    Returns true if the indicated client is a simulator
    Parameters:
    clientName - name of the client
    Returns:
    false if the indicated client is not registered or is realtime
deregister
public void deregister(java.lang.String clientName)
    Changes the indicated client's registration flag to false. Nothing occurs if the
    client is not in the table.
    Parameters:
    clientName - name of the client to deregister
clean
public boolean clean( )
    Iterates through the table and closes the logger and removes any client that is
    markes as not registered.
    Returns:
    false if there is a problem closing the logger for one or more of the
    deregistered clients
getSimClients
public java.util.Collection getSimClients( )
    Returns a collection of the registered simulation clients
    Returns:
    list of the simulation clients
getRealtimeClients
public java.util.Collection getRealtimeClients( )
    Returns a collection of the registered realtime clients
    Returns:
    list of realtime clients
getNumDone
public int getNumDone( )
    Returns the number of registered clients that have sent a done
    Returns:
    the number of simulation clients that are done
```

Interface CommHubConnection

public interface CommHubConnection

Interface for all connections that are created and maintained by CommHub. At least one class for each communications protocol handled by CommHub must be created and it must implement this interface.

Method Summary

| | |
|---|---|
| boolean | addHandler(MessageHandler handler) |
| | Adds a message handler to the connection. |
| void | close( ) |
| | Close all open connections gracefully. |
| void | finishLogging( ) |
| | Stops the logger and blocks until all output on the |
| | logger has finished |
| java.lang.String | getName( ) |
| | Returns the name of the connection, for debugging |
| | purposes |
| void | updateTime(double time) |
| | Sets the current simulation time in the connection. |

Method Detail

```
addHandler
public boolean addHandler(MessageHandler handler)
    Adds a message handler to the connection. If this connection does
    not support this type of handler, return false
    Parameters:
    handler - a message handler that deals with certain types of messges.
    Message handlers are usually used to reformat a message before it
    is sent through CommHub.
    Returns:
    true if this object can use handlers of this type, false otherwise
finishLogging
public void finishLogging()
        throws java.lang.InterruptedException
    Stops the logger and blocks until all output on the logger has finished
    Throws:
    java.lang.InterruptedException - if there is a problem waiting for the
    logger to finish its output
updateTime
public void updateTime(double time)
    Sets the current simulation time in the connection.
    Parameters:
    time - the current time in number of seconds from start of simualtion
getName
public java.lang.String getName()
    Returns the name of the connection, for debugging purposes
    Returns:
    name of the connection
close
public void close()
      throws CommunicationsException
    Close all open connections gracefully.
    Throws:
    CommunicationsException - if there is a problem closing the
    connections
```

Interface CommHubConnectionFactory

public interface CommHubConnectionFactory

Objects that inherit from this interface creates a CommHubConnection object using the data stored in the passed in doc. Each communications protocol must have at least one factory that implements this interface.

Method Summary

| | |
|---|---|
| CommHubConnection | generateConnection(org.w3c.dom.Element doc, |
| | CommunicationsHandler handler) |
| | Generates a CommHubConnection |
| | with all the connections configured and |
| | ready for input and/or output. |

Method Detail

generateConnection
public CommHubConnection generateConnection(org.w3c.dom.Element
doc, CommunicationsHandler handler)
throws
CommHubConnectionFactoryException

Generates a CommHubConnection with all the connections configured and ready for input and/or output.

Parameters:

doc—contains all the info need to create the commonnection

handler—handles all packaged messages

Returns:

a new and configured connection via some communications protocol

Throws:

CommHubConnectionFactoryException—if there is a problem setting up the connection

Class CommHubConnectionFactoryException

public class CommHubConnectionFactoryException

extends java.lang.Exception

Thrown when the CommHubConnectionFactory encounters a problem generating a CommHubConnection

Constructor Summary

```
CommHubConnectionFactoryException( )
    Constructor
CommHubConnectionFactoryException(java.lang.String message)
    Constructor
CommHubConnectionFactoryException(java.lang.String message,
java.lang.Throwable cause)
    Constructor
CommHubConnectionFactoryException(java.lang.Throwable cause)
    Constructor
```

Methods inherited from class java.lang.Throwable

fillInStackTrace, getCause, getLocalizedMessage, getMessage,
getStackTrace, initCause, printStackTrace, printStackTrace,
printStackTrace, setStackTrace, toString

Methods inherited from class java.lang.Object

clone, equals, finalize, getClass, hashCode, notify, notifyAll, wait,
wait, wait

Constructor Detail

```
CommHubConnectionFactoryException
public CommHubConnectionFactoryException( )
    Constructor
CommHubConnectionFactoryException
public CommHubConnectionFactoryException(java.lang.String message)
    Constructor
Parameters:
    message - error message
CommHubConnectionFactoryException
public CommHubConnectionFactoryException(java.lang.String message,
                            java.lang.Throwable cause)
    Constructor
Parameters:
    message - error message
    cause - nested throwable
CommHubConnectionFactoryException
public CommHubConnectionFactoryException(java.lang.Throwable cause)
    Constructor
Parameters:
    cause - nested throwable
```

Class CommunicationsException

public class CommunicationsException

extends java.lang.Exception

Class used to package communications exceptions from a CallbackReference.

Constructor Summary

```
CommunicationsException( )
      Default Constructor
CommunicationsException(java.lang.String message)
      Constructor
CommunicationsException(java.lang.String message,
java.lang.Throwable cause)
      Constructor
CommunicationsException(java.lang.Throwable cause)
      Constructor
```

Methods inherited from class java.lang.Throwable

fillInStackTrace, getCause, getLocalizedMessage, getMessage,
getStackTrace, initCause, printStackTrace, printStackTrace,
printStackTrace, setStackTrace, toString

Methods inherited from class java.lang.Object

clone, equals, finalize, getClass, hashCode, notify, notifyAll, wait,
wait, wait

Constructor Detail

```
CommunicationsException
public CommunicationsException( )
      Default Constructor
CommunicationsException
public CommunicationsException(java.lang.String message)
      Constructor
Parameters:
      message - text describing the problem
CommunicationsException
public CommunicationsException(java.lang.String message,
                              java.lang.Throwable cause)
      Constructor
Parameters:
      message - text message describing the problem
      cause - a throwable object that is the original cause of the problem
CommunicationsException
public CommunicationsException(java.lang.Throwable cause)
      Constructor
Parameters:
      cause - throwable object that is the original cause of the problem
```

Interface CommunicationsHandler

All Known Implementing Classes:

public interface CommunicationsHandler

Interface implemented by objects that handle communications from clients. Typically, listeners have a reference to an object that implements this interface and they use the methods to pass the messages into the system.

Method Summary

| | |
|---|---|
| boolean | addHandler(MessageHandler handler) |
| | Adds a new message handler to one of the |
| | connections objects. |
| CommHubConnection | getConnection(java.lang.String name) |
| | Returns the connection with the passed in |
| | name. |
| double | getCurrentSimTime( ) |
| | Returns the current simulation time. |
| void | handleException(java.lang.Exception e) |
| | Called when an exception occurs that |
| | cannot be handled by the caller |
| short | messageHandler(MessageObject mo) |
| | Adds a message to a client's message |
| | queue. |
| void | println(java.lang.String line) |
| | Occasionally it is useful to print to the |
| | handler's log file rather then the listener's log file. |
| short | registerNewClient(ClientRef client) |
| | Called when the listener receives a new |
| | client registration |
| void | setClientDone(java.lang.String client) |
| | Called to inform the handler that a client |
| | has finished processing for the current time step. |

Method Detail

```
handleException
public void handleException(java.lang.Exception e)
      Called when an exception occurs that cannot be handled by the
      caller
      Parameters:
      e - the exception
registerNewClient
public short registerNewClient(ClientRef client)
      Called when the listener receives a new client registration
      Parameters:
      client - the client to be registered
      Returns:
      0 if there is no problem registering the client
addHandler
public boolean addHandler(MessageHandler handler)
      Adds a new message handler to one of the connections objects.
      If there is no connection that uses handlers of the passed in type,
      false is returned.
      Parameters:
      handler - a message handler that transforms and packages incoming
      messages before it gets to this object
      Returns:
      true if successfully added, false otherwise
getConnection
public CommHubConnection getConnection(java.lang.String name)
      Returns the connection with the passed in name.
      Parameters:
      name - the name of the connection being asked for
      Returns:
      the connection with the passed in name, or null if there is no
      connection with that name.
setClientDone
public void setClientDone(java.lang.String client)
      Called to inform the handler that a client has finished processing for
      the current time step.
      Parameters:
      client - the name of the client that has finished
messageHandler
public short messageHandler(MessageObject mo)
      Adds a message to a client's message queue. All the info is stored in
      the MessageObject
      Parameters:
      mo - contains all the information about a message including source,
      destination, and the message itself.
      Returns:
      0 if there is no problem with the message
println
public void println(java.lang.String line)
      Occasionally it is useful to print to the handler's log file rather then
      the listener's log file.
      Parameters:
      line - message to print
getCurrentSimTime
public double getCurrentSimTime( )
      Returns the current simulation time. If the simulation is not running,
      then 0.0 is returned
      Returns:
      the current simulation time
```

Class Connections

public class Connections

extends java.util.Hashtable

Maintains a reference to all of the active connections in CommHub.

Constructor Summary

Connections( )
Constructor

Method Summary

| | |
|---|---|
| java.lang.Object | addConnection(CommHubConnection connection) |
| | Adds a new connection object to the list |
| boolean | addHandler(MessageHandler handler) |
| | Adds a new message handler to one of the |
| | connections. |
| void | close( ) |
| | Closes all of the connections. |
| void | finishLogging( ) |
| | Stops the loggers in all the connections and |
| | blocks until they are done writing their cached |
| | statements. |
| void | updateTime(double time) |
| | Undates the current time in all the connections |

Methods inherited from class java.util.Hashtable

clear, clone, contains, containsKey, containsValue, elements,
entrySet, equals, get, hashCode, isEmpty, keys, keySet, put, putAll,
rehash, remove, size, toString, values

Methods inherited from class java.lang.Object

finalize, getClass, notify, notifyAll, wait, wait, wait

Constructor Detail

Connections
public Connections( )
Constructor

Method Detail

```
addConnection
public java.lang.Object addConnection(CommHubConnection connection)
        Adds a new connection object to the list
        Parameters:
        connection - a CommHub connection
        Returns:
        if the connection name is the same as a previous connection name, the
        previous connection is returned, otherwise null is returned.
finishLogging
public void finishLogging( )
        Stops the loggers in all the connections and blocks until they are done writing
        their cached statements.
updateTime
public void updateTime(double time)
        Undates the current time in all the connections
        Parameters:
        time - the new time
addHandler
public boolean addHandler(MessageHandler handler)
        Adds a new message handler to one of the connections. Chain of responsibility
        is used to determine which connection uses the handler.
        Parameters:
        handler - the new message handler
        Returns:
        true if the handler is successfully registered, false is there is no connection
        setup to use this handler.
close
public void close( )
        Closes all of the connections.
```

Interface MessageHandler

public interface MessageHandler

Interface used to identify and manage all objects that handle messages. The methods defined by the handlers and what they do is defined by the CommHubConnection object that uses them. It is left open because the way to handle a JMS message is drastically different then handleing a CORBA message.

Class MessageObject

public class MessageObject

extends java.lang.Object

Encapsulates a message system. It contains the message contents, the name of the source client, name of the destination client, and the time the message was sent in seconds.

Field Summary

| | |
|---|---|
| protected | _clientName |
| java.lang.String | The name of the sending client |
| protected | _destination |
| java.lang.String | The name of the destination client |
| protected | _messageType |
| java.lang.String | The type of message |
| protected double | _timeSent |
| | The time the message was sent in seconds |
| protected | _value |
| java.lang.Object | The actual message contents |

Constructor Summary

| | |
|---|---|
| MessageObject( ) | |
| Default constructor. | |
| MessageObject(double timeSent, | java.lang.String clientName, |
| java.lang.String destination, | java.lang.Object value, |
| java.lang.String messageType) | |
| Constructor | |
| MessageObject(double timeSent, | java.lang.String clientName, |
| java.lang.String destination, | java.lang.String xmlMessage) |
| Constructor. | |

Method Summary

| | |
|---|---|
| java.lang.String | getClientName( ) |
| | Returns the source client's name |
| java.lang.String | getDestination( ) |
| | Returns the destination clients name |
| java.lang.String | getMessageType( ) |
| | Returns the message type |
| static java.lang.String | getMessageType(java.lang.String xmlMessage) |
| | Extracts the root element of xmlMessage and |
| | uses it as the message type. |
| double | getTimeSent( ) |
| | Returns the time the message was sent in |
| | seconds |
| java.lang.Object | getValue( ) |
| | Returns the value of the message |
| void | setClientName(java.lang.String name) |
| | Sets the name of the client that originated the |
| | message |
| void | setDestination(java.lang.String destination) |
| | Sets the destination |
| void | setMessageType(java.lang.String |
| | messageType) |
| | Sets the message type |
| void | setTimeSent(double newTime) |
| | Sets the time associated with this message. |
| void | setValue(java.lang.Object obj) |
| | Sets the value |
| java.lang.String | toString( ) |
| | Returns a string representation of the object |

Methods inherited from class java.lang.Object

clone, equals, finalize, getClass, hashCode, notify, notifyAll, wait,
wait, wait

Field Detail

```
_value
protected java.lang.Object _value
    The actual message contents
_clientName
protected java.lang.String _clientName
    The name of the sending client
_destination
protected java.lang.String _destination
    The name of the destination client
_timeSent
protected double_timeSent
    The time the message was sent in seconds
_messageType
protected java.lang.String _messageType
```

The type of message

Constructor Detail

```
MessageObject( )
public MessageObject( )
    Default constructor.Initializes everything to null.
MessageObject
public MessageObject(double timeSent,
            java.lang.String clientName,
            java.lang.String destination,
            java.lang.String xmlMessage)
    Constructor.
Parameters:
    timeSent - time the message was sent
    clientName - unique identifier for the source client
    destination - unique identifier for the destination client
    xmlMessage - contents of the message
MessageObject
public MessageObject(double timeSent,
            java.lang.String clientName,
            java.lang.String destination,
            java.lang.Object value,
            java.lang.String messageType)
```

Constructor

Parameters:

timeSent—time the message was sent

clientName—unique identifier for the source client

destination—unique identifier for the destination client

value—contents of the message

messageType—the type of the message

Method Detail

```
getMessageType
public static java.lang.String
getMessageType(java.lang.String xmlMessage)
        Extracts the root element of xmlMessage and uses it as the message type. This
        function assumes xmlMessage is XML formatted. The results are
        unpredictible otherwise.
        Parameters:
        xmlMessage - an XML formatted string
        Returns:
        the root element or null if there was a problem parsing the message
getMessageType
public java.lang.String getMessageType( )
    Returns the message type
    Returns:
    null if the type has not been set
setMessageType
public void setMessageType(java.lang.String messageType)
        Sets the message type
        Parameters:
        messageType - Sring representing the message type
getValue
public java.lang.Object getValue( )
        Returns the value of the message
        Returns:
        null if the value has not been set
setValue
public void setValue(java.lang.Object obj)
        Sets the value
        Parameters:
        obj - a new value for the message
getClientName
public java.lang.String getClientName( )
        Returns the source client's name
        Returns:
        null if the name hasn't been set
setClientName
public void setClientName(java.lang.String name)
        Sets the name of the client that originated the message
        Parameters:
        name - name of the souirce client
getDestination
public java.lang.String getDestination( )
        Returns the destination clients name
        Returns:
        null if the destination hasn't been set
setDestination
public void setDestination(java.lang.String destination)
        Sets the destination
        Parameters:
        destination - the name of the destination client
getTimeSent
public double getTimeSent( )
        Returns the time the message was sent in seconds
        Returns:
        −1 if the time hasn't been set yet
setTimeSent
public void setTimeSent(double newTime)
        Sets the time associated with this message.
        Parameters:
        newTime - the new time to associate with the message
toString
public java.lang.String toString( )
        Returns a string representation of the object
        Returns:
        a nicely formatted version of the message
```

What is claimed is:

1. A system for communicating messages between applications, comprising:
an incoming connection component, operable to:
receive messages from a sending application, and
wrap the messages as a generic object in a message object;
a core logic component coupled to the incoming connection component and operable to receive the message object from the incoming connection component;
an outgoing connection component coupled to the core logic component and operable to:
receive the message object from the core logic component,
unwrap the message object to retrieve the message,
prepare the message for delivery to a destination application, and
deliver the message to the destination application;
wherein the incoming connection component, the core logic component, and the outgoing connection component function together as an integrated unit; and
wherein the incoming connection component, the core logic component, and the outgoing connection component function have standardized interfaces.

2. The system of claim 1, wherein:
the sending application sends messages in a first format and the destination application receives messages in a second format; and
one of the incoming connection component, the outgoing connection component, or the core logic component directly converts the message from the first format to the second format.

3. The system of claim 1, wherein the generic object in the message object is XML formatted.

4. The system of claim 1, wherein the incoming connection component and the outgoing connection component are runtime configurable.

5. A system for communicating messages between applications, comprising:
an incoming connection component, operable to:
receive messages from a sending application, and
wrap the messages as a generic objects in message objects;
a core logic component coupled to the incoming connection component and operable to receive the message object from the incoming connection component;
an outgoing connection component coupled to the core logic component and operable to:
receive the message object from the core logic component,
unwrap the message object to retrieve the message,
prepare the message for delivery to a destination application, and
deliver the message to the destination application.

6. The system of claim 5, wherein the incoming connection component, the core logic component, and the outgoing connection component function all have standardized interfaces.

7. The system of claim 5, wherein the incoming connection component, the core logic component, and the outgoing connection component function together as an integrated unit.

8. The system of claim 7, wherein the incoming connection component and the outgoing connection component are runtime configurable.

9. The system of claim 7, wherein the generic object in the message object is XML formatted.

10. The system of claim 7, wherein
the sending application sends messages in a first format and the destination application receives messages in a second format; and
one of the incoming connection component, the outgoing connection component, or the core logic component directly converts the message from the first format to the second format.

11. The system of claim 7, wherein the core logic component includes:
a message handler and a simulation driver, the message handler operable to process message objects received from the incoming connection component and the simulation driver operable to transmit a clock information message to the message handler to add timing information to the message objects.

12. The system of claim 5, wherein:
the incoming connection component is a plurality of incoming connection components;
the plurality of incoming connection components receive messages from a plurality of sending applications;
the core logic component implements a communication handler interface; and
each of the plurality of incoming connection objects implements a connection object within the communication handler interface, each of the connection objects operable to:
receive a message from at least one of the plurality of sending applications,
wrap the received message as a generic object in a message object, and
transfer the message object to the communication handler.

13. The system of claim 12, further comprising:
a connections class, operable to store the plurality of connection object, and listen for incoming messages and implement the pertinent connection object to receive the incoming message.

14. The system of claim 12, further comprising:
a connections factory operable to:
read a configuration file, and
create a connection object from the configuration file.

15. The system of claim 14, wherein the configuration is a parsed XML document.

16. The system of claim 7, wherein:
the outgoing connection component is a plurality of outgoing connection components;
the plurality of outgoing connection components deliver messages to a plurality of destination applications;
the core logic component implements a communication handler interface, and
each of the plurality of outgoing connection objects implements a clienref object within the communication handler interface, each clientref object operable to:
receive the message object from the communication handler;
store destination information corresponding to at least one destination application; and
contain at least one callback reference interface, the at least one callback reference operable to:
unwrap the received message from the message object,
prepare the message for delivery to the destination application, and
deliver the message to the destination application.

17. The system of claim 16, wherein:
the incoming connection component is a plurality of incoming connection components;
the plurality of incoming connection components receive messages from a plurality of sending applications;
each of the plurality of incoming connection objects implements a connection object within the communication handler interface, each of the connection objects operable to:
receive a message from at least one of the plurality of sending applications,
wrap the received message as a generic object in a message object, and
transfer the message object to the communication handler.

18. A method of communicating a message from a first application to a second application, comprising:
receiving, at an incoming connection component, a message from the first application;
wrapping, at the incoming connection component, the message as a generic object in a message object,
communicating, through a core logic component, the message object to a outgoing connection component;
unwrapping, at the outgoing connection component, the message object to retrieve the message;
preparing, at the outgoing connection component, the message for delivery to the second application; and
communicating, from the outgoing connection component, the message to the second application, wherein the core logic component, the incoming connection component, and the outgoing connection component function together as an integrated unit.

19. The method of claim 18, wherein
the first application sends the messages in a first format and the second application receives messages in a second format,
receiving the message from the first application the further includes receiving the message in the first format,
communicating the message to the second application further includes communicating the message in the second format, the method further comprising:
directly converting the message received in the first format to a message received in the second format.

20. The method of claim 18, wherein the generic object in the message object is XML formatted.
